(19) United States
(12) Patent Application Publication
(10) Pub. No.: US 2017/0298895 A1
(43) Pub. Date: Oct. 19, 2017

(54) GREEN POWER GENERATION SYSTEM AND METHOD

(71) Applicant: TRUE TEN INDUSTRIAL CO., LTD., Taichung City (TW)

(72) Inventor: SHUN-TSUNG LU, Taichung City (TW)

(21) Appl. No.: 15/131,019

(22) Filed: Apr. 17, 2016

(51) Int. Cl. F03B 13/06; F03B 7/00; F03B 17/06; F03G 6/02

(52) U.S. Cl. CPC F03B 13/06; F03G 6/02; F03B 7/00; F03B 17/065

(57) ABSTRACT

The present disclosure first uses a pumping device to retrieve water using an internal power source from a water source. Then, in accordance with a wind parameter and a solar parameter, wind-powered and solar-powered pumping devices are selectively engaged to replace the pumping device. The water is stored in the water storage device in a higher place. As the water runs through an inlet pipe, it is pressurized to drive a first hydraulic generation device. Then the water's potential energy is used to drive a second hydraulic generation device as the water is recycled to the water source. The produced electricity is delivered to the pumping device and, if any remaining, then to a light device for illumination.

### BACKGROUND OF THE INVENTION

### (a) Technical Field of the Invention

The present invention is generally related to green power, and more particular to a system and a related method of integrally harnessing wind power, solar power, and hydraulic power.

### (b) Description of the Prior Art

Green power generation is the trend for the future. Among the various green power sources, wind power is often not persistent, and requires a certain degree of wind strength. Wind power generation therefore cannot sustain for a long period of time. Hydraulic power requires abundant water resource but water cannot be recycled. On the other hand, solar power is limited by climate condition and sunbeam direction.

Whether it is wind, solar, or hydraulic power that is harnessed, the generation device is usually designed for a single source. These green power sources are often not integrated and harnessed together.

### SUMMARY OF THE INVENTION

A major objective of the present application is to integrate wind power, solar power and hydraulic power to recycle water resources and to produce electricity continuously with a limited amount of water.

The present disclosure teaches a green power generation system contains a pumping device, a wind-powered pumping device, a solar-powered pumping device, a water storage device, a first hydraulic generation device, a second hydraulic generation device, and a lighting device. The water storage device contains a container, an inlet pipe, and an outlet pipe. The system first uses the pumping device to retrieve water using an internal power source from a water source. Then, in accordance with a wind parameter and a solar parameter, the wind-powered and solar-powered pumping devices are selectively engaged to replace the pumping device. The water is stored in the water storage device in a higher place. As the water runs through the inlet pipe, it is pressurized to drive the first hydraulic generation device. Then the water's potential energy is used to drive the second hydraulic generation device as the water is recycled to the water source. The produced electricity is delivered to the pumping device and, if any remaining, then to the light device for illumination.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a functional block diagram showing a green power generation system according to an embodiment of the present invention.

FIG. 2 is a schematic diagram showing the green power generation system of FIG. 1.

FIG. 3 is a flow diagram showing a green power generation method according to an embodiment of the present invention.

FIG. 4 is flow diagram showing decisions performed by the green power generation method of FIG. 3.

FIG. 5 is a schematic diagram showing an operation scenario of the green power generation system of FIG. 1.

FIG. 6 is a schematic diagram showing another operation scenario of the green power generation system of FIG. 1.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

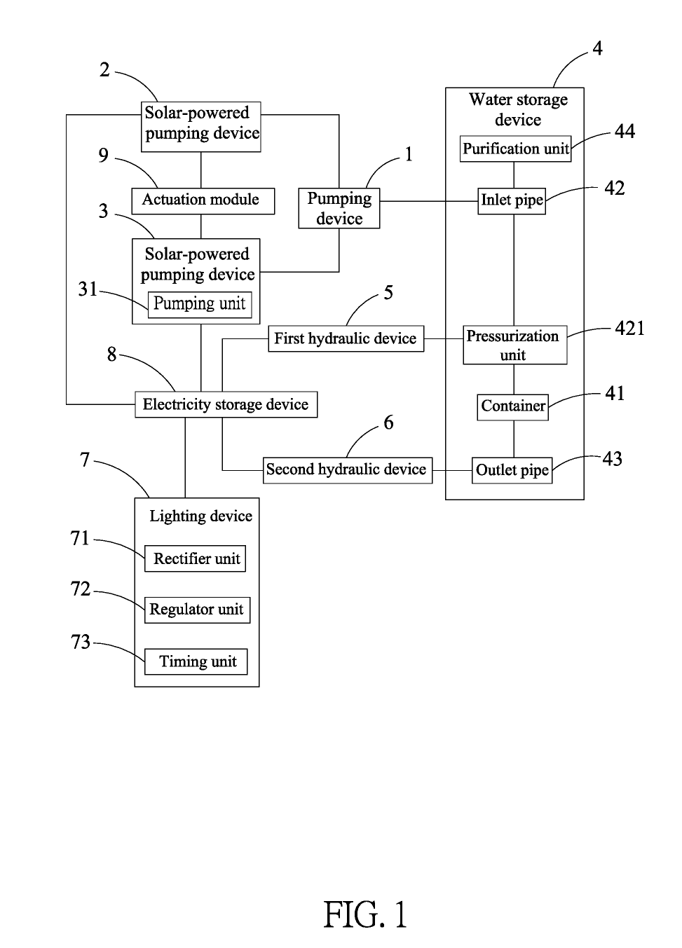

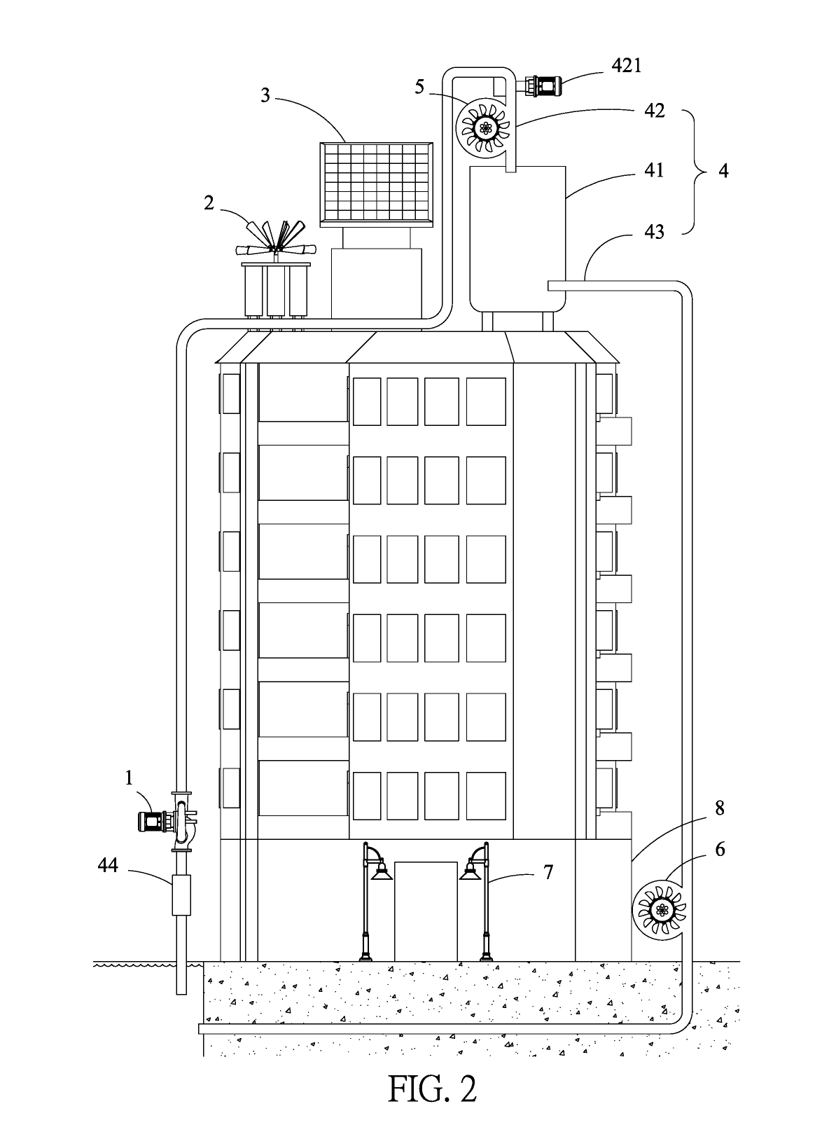

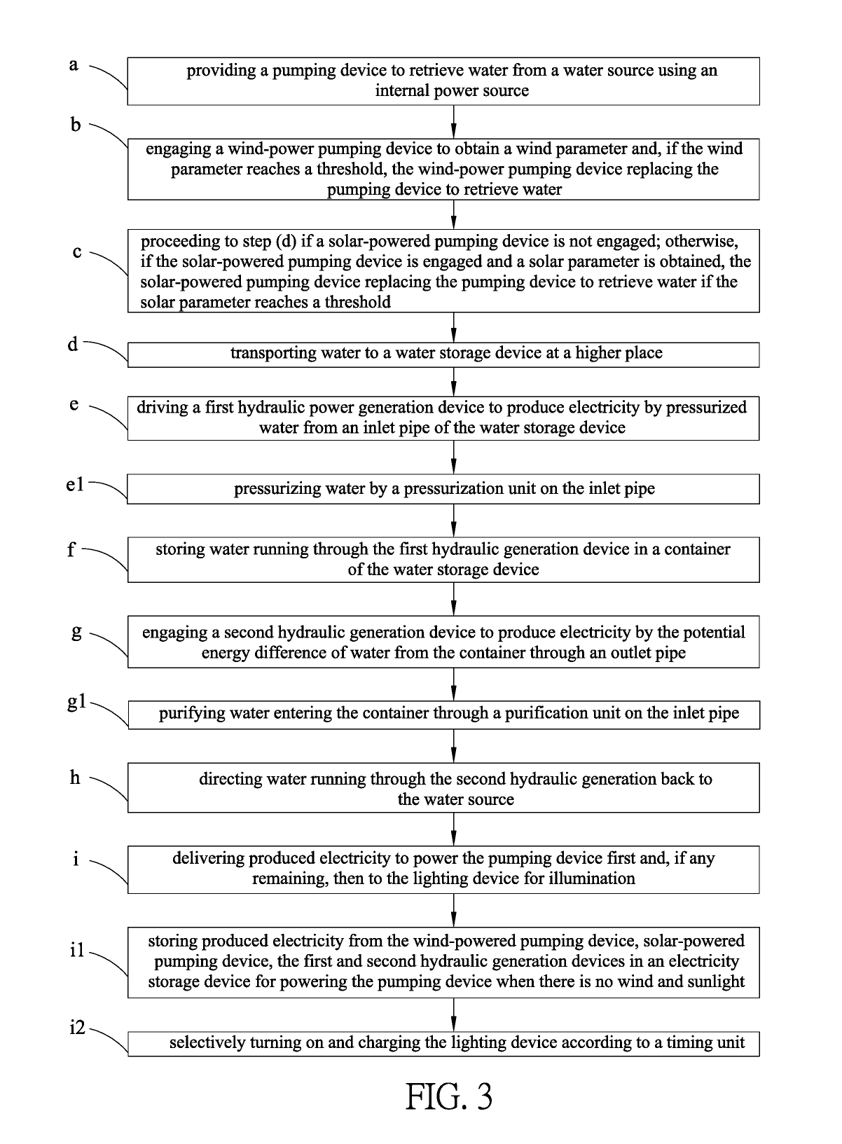

As shown in FIGS. 1 to 3, a green power generation system according to an embodiment of the present invention contains the following components.

A pumping device 1 is provided for retrieving water.

A wind-powered pumping device 2 is electrically connected to the pumping device 1, which is actuated when a wind parameter reaches a threshold and replaces the operation of the pumping device 1.

A solar-powered pumping device 3 is electrically connected to the pumping device 1, which is actuated when a solar parameter reaches a threshold and replaces the operation of the pumping device 1. The solar-powered pumping device 3 contains a pump unit 21. The solar-powered pumping device 3 may operate independently to retrieve water, or simply provide electricity to the pumping device 1.

An actuation module 9 is electrically connected to the pumping device 1, the wind-powered pumping device 2, and the solar-powered pumping device 3, which is for setting up the wind and solar parameters and a time interval, and is for switching the pumping devices.

A water storage device 4 is disposed above the pumping device 1 and is connected to the pumping device 1, the wind-powered pumping device 2, and the solar-powered pumping device 3. The water storage device 4 contains a container 41, an inlet pipe 42 whose two ends connect the pumping device 1 and the container 41, respectively, an outlet pipe 43 whose two ends connect the container 41 and a water source, respectively, a purification unit 44 on the inlet pipe 42, and a pressurization unit 421 on the inlet pipe 42 for driving water to engage a first hydraulic generation device 5.

The first hydraulic generation device 5 is configured above the container 41 and is engaged by the water delivered by the inlet pipe 42. A second hydraulic generation device 6 is configured along the outlet pipe 43 which is driven by the water in the container 41's potential energy.

A lighting device 7 is electrically connected to the wind-powered pumping device 2, the solar-powered pumping device 3, the first hydraulic generation device 5, and the second hydraulic generation device 6. The light device 7 contains an AC-DC rectifier unit 71, a regulator unit 72, and a timing unit 73. The rectifier unit 71 and the regulator unit 72 are for charging the lighting device 7, and the timing unit 73 is for turning on the lighting device 7 and for charging the lighting device 7 at specific times.

An electricity storage device 8 is electrically connected to the wind-powered pumping device 2, the solar-powered pumping device 3, the first hydraulic generation device 5, and the second hydraulic generation device 6.

A green power generation method according to an embodiment of the present invention contains the following steps:
(a) an internal power source drives a pumping device to retrieve water from a water source;
(b) a wind-power pumping device is engaged to obtain a wind parameter and, if the wind parameter reaches a threshold, the wind-power pumping device replaces the pumping device to retrieve water;
(c) if a solar-powered pumping device is not engaged, the method proceeds to step (d); otherwise, if the solar-powered pumping device is engaged and a solar parameter is produced, the solar-powered pumping device replaces the pumping device to retrieve water if the solar parameter reaches a threshold;
(d) water is transported to a water storage device at a high place;
(e) a first hydraulic power generation device is engaged to produce electricity by pressurized water from an inlet pipe of the water storage device (more specifically, the water is pressurized by a pressurization unit);
(f) a container of the water storage device stores the water running through the first hydraulic generation device;
(g) a second hydraulic generation device is engaged to produce electricity by the potential energy difference of water from the container through an outlet pipe (more specifically, a purification unit is configured along the inlet pipe to purify water entering the container);
(h) water running through the second hydraulic generation device is directed back to the water source from which the pumping device is retrieving through the outlet pipe;
(i) produced electricity is delivered to power the pumping device first and, if any remaining, is then delivered to the lighting device for illumination (more specifically, electricity produced from the wind-powered pumping device, solar-powered pumping device, the first and second hydraulic generation devices is stored in a electricity storage device for powering the pumping device when there is no wind and sunlight; and a timing unit is employed to selectively turning on and charging the lighting device.

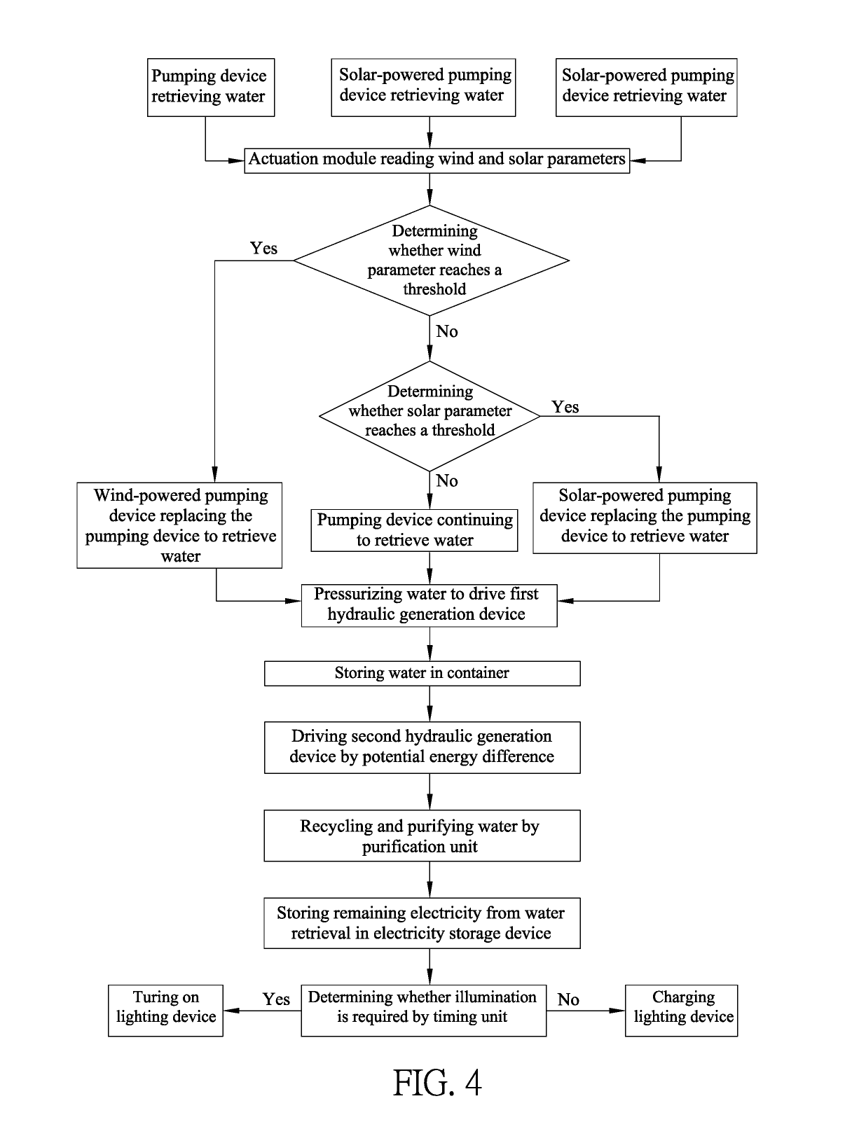

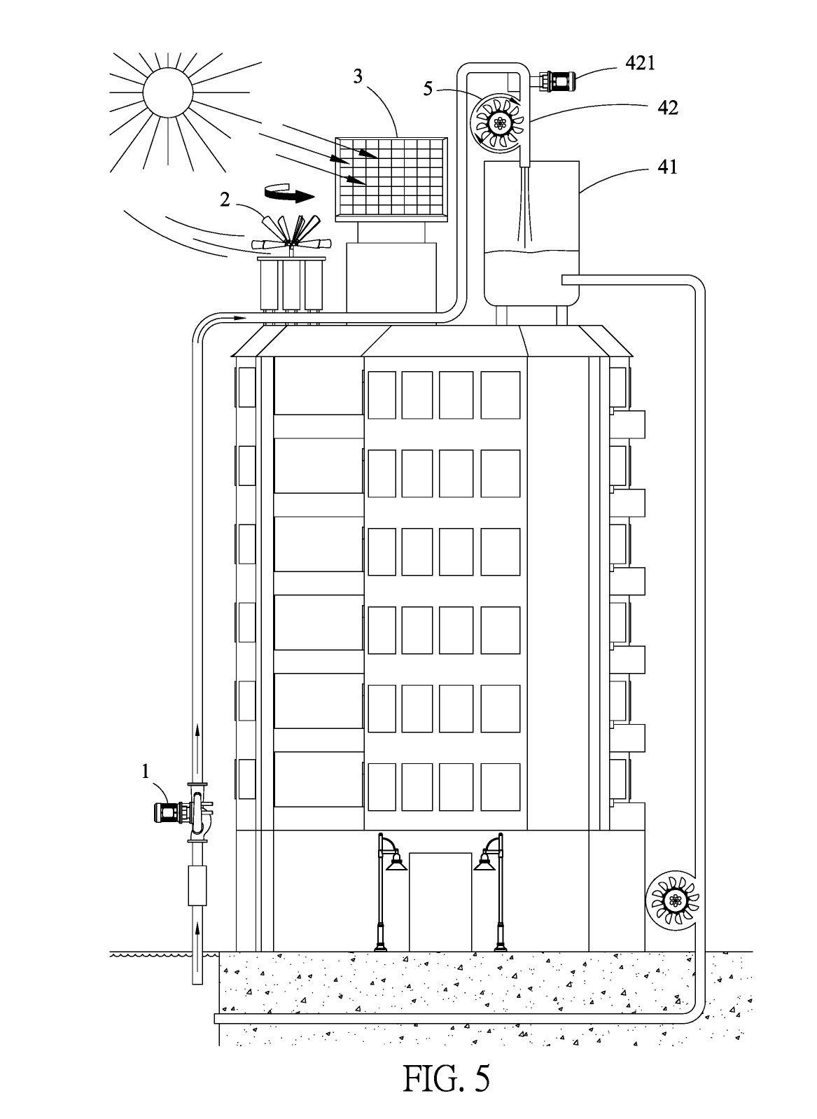

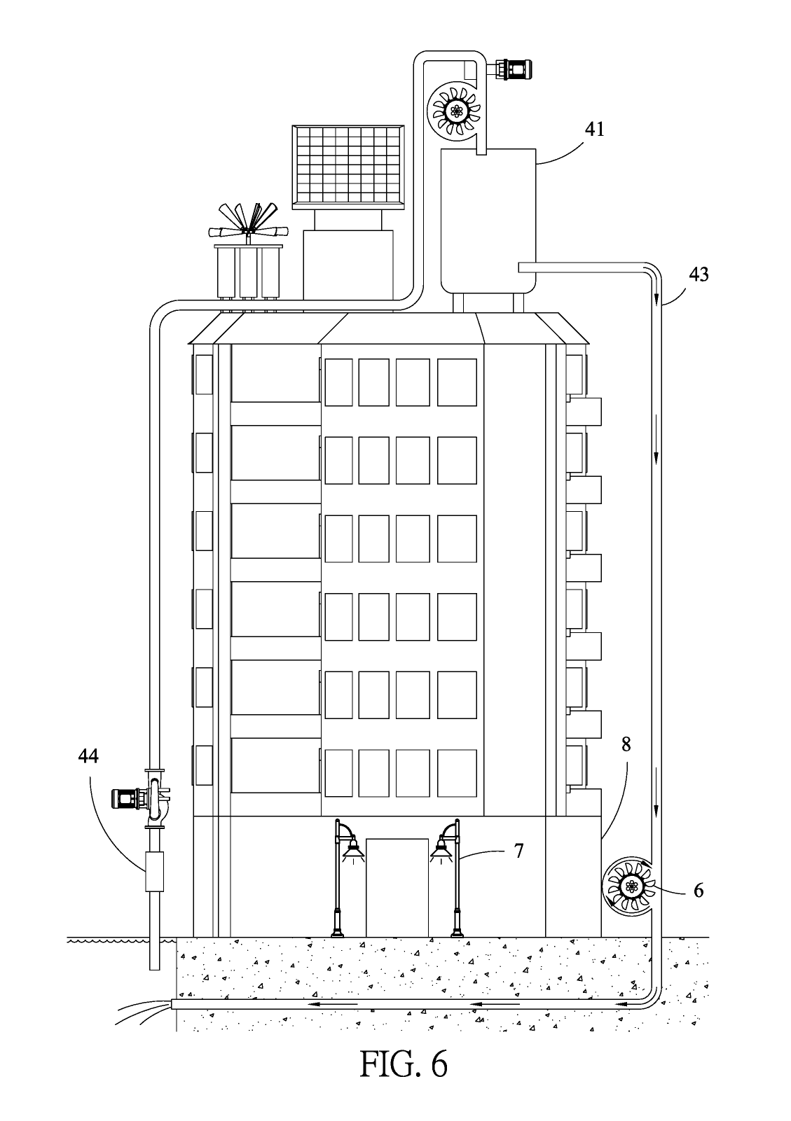

As shown in FIGS. 1 to 6, the present embodiment first engages the pumping device 1 to retrieve water using its internal power source while the wind-powered pumping device 2 and the solar-powered pumping device 3 are standing by. When there is wind, the wind parameter obtained by the wind-powered pumping device 2 would be greater than 0 When there is sunlight, the solar parameter obtained by the solar-powered pumping device 3 would be greater than 0 The actuation module 9 reads the wind and solar parameters (i.e., electricity that could be produced within a unit of time), and determines if the two pumping devices 2 and 3 should be actuated. When any one of the parameters reaches a threshold, a first mode of electricity generation is conducted where the pumping device 1 is switched to be powered by the electricity produced by the wind-powered or solar-powered pumping device 2 or 3. If both parameters do not reach the threshold, then it is determined that whether the water retrieved by the pumping device 1 is capable of producing enough electricity for the pumping device 1's operation so as to change the power source of the pumping device 1.

The wind-powered and solar-powered pumping devices 2 and 3 operate using the siphon principle. The water is retrieved to the water storage device 4 at a higher place and, before the water enters the container 41, the water is pressurized using the pressurization unit 421 on the inlet pipe 42 so as to drive the first hydraulic generation device 5 in a second mode of electricity generation. The water in the container 41 is then directed to the water source through the outlet pipe 43 by gravity and, along the process, the water drives the second hydraulic generation device 6 so as the convert the water's potential energy into electrical energy in a third mode of electricity generation. After driving the second hydraulic generation device 6, the water continues to flow back to the water source.

The present invention therefore provides long-term electricity generation utilizing only a limited amount of water. The produced electricity is further stored in the electricity storage device 8 for the pumping device 1 in case there is no wind or sunlight. The produced electricity can also be directed to the light device 7. With the control of the timing unit 73, the electricity can be used to charge or discharge. For example, from 0800 to 1600, the produced electricity is converted into low-level stable DC by the rectifier unit 71 and the regulator unit 72 for charging. Then, from 18:00 to 0600, the produced electricity is directly supplied to the lighting device 7 for illumination. The present embodiment also utilizes a purification unit 44 so that the water not only can be used for electricity generation but also can be used for household consumption.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the claims of the present invention.

I claim:

1. A green power generation system, comprising:
a pumping device for retrieving water from a water source;
a wind-powered pumping device electrically connected to the pumping device, which is actuated when a wind parameter reaches a threshold and replaces the operation of the pumping device;
a solar-powered pumping device electrically connected to the pumping device, which is actuated when a solar parameter reaches a threshold and replaces the operation of the pumping device,
a water storage device disposed above the pumping device and connected to the pumping device, the wind-powered pumping device, and the solar-powered pumping device, where the water storage device comprises a container, an inlet pipe whose two ends connect the pumping device and the container, respectively, and an outlet pipe whose two ends connect the container and the water source, respectively;
a first hydraulic generation device configured above the container and engaged by the water delivered by the inlet pipe;
a second hydraulic generation device configured along the outlet pipe driven by the water in the container's potential energy; and
a lighting device electrically connected to the wind-powered pumping device, the solar-powered pumping device, the first hydraulic generation device, and the second hydraulic generation device.

2. The green power generation system according to claim 1, further comprising an electricity storage device electrically connected to the wind-powered pumping device, the solar-powered pumping device, the first hydraulic generation device, and the second hydraulic generation device.

3. The green power generation system according to claim 1, wherein the water storage device further comprises a pressurization unit on the inlet pipe for driving water to engage a first hydraulic generation device.

4. The green power generation system according to claim 1, further comprising an actuation module electrically connected to the pumping device, the wind-powered pumping device, and the solar-powered pumping device, which is for setting up the wind and solar parameters and a time interval, and is for switching the pumping devices.

5. The green power generation system according to claim 1, wherein the solar-powered pumping device comprises a pump unit.

6. The green power generation system according to claim 1, wherein the lighting device comprises an AC-DC rectifier unit, and a regulator unit where he rectifier unit and the regulator unit are for charging the lighting device.

7. The green power generation system according to claim 1, wherein the lighting device comprises a timing unit is for turning on the lighting device and for charging the lighting device at specific times.

8. A green power generation method, comprising the steps of:
(a) providing a pumping device to retrieve water from a water source using an internal power source;
(b) engaging a wind-power pumping device to obtain a wind parameter and, if the wind parameter reaches a threshold, the wind-power pumping device replacing the pumping device to retrieve water;
(c) proceeding to step (d) if a solar-powered pumping device is not engaged; otherwise, if the solar-powered pumping device is engaged and a solar parameter is obtained, the solar-powered pumping device replacing the pumping device to retrieve water if the solar parameter reaches a threshold;
(d) transporting water to a water storage device at a higher place;
(e) driving a first hydraulic power generation device to produce electricity by pressurized water from an inlet pipe of the water storage device;
(f) storing water running through the first hydraulic generation device in a container of the water storage device;
(g) engaging a second hydraulic generation device to produce electricity by the potential energy difference of water from the container through an outlet pipe;
(h) directing water running through the second hydraulic generation back to the water source; and
(i) delivering produced electricity to power the pumping device first and, if any remaining, then to the lighting device for illumination.

9. The green power generation system according to claim 8, wherein the step (g) further comprises the step of:
purifying water entering the container through a purification unit on the inlet pipe.

10. The green power generation system according to claim 8, wherein the step (e) further comprises the step of:
pressurizing water by a pressurization unit on the inlet pipe.

11. The green power generation system according to claim 8, wherein the step (i) further comprises the step of:
storing produced electricity from the wind-powered pumping device, solar-powered pumping device, the first and second hydraulic generation devices in an electricity storage device for powering the pumping device when there is no wind and sunlight.

12. The green power generation system according to claim 11, wherein the step (i) further comprises the step of:
selectively turning on and charging the lighting device according to a timing unit.

13. The green power generation method according to claim 8, wherein an actuation module is electrically connected to the pumping device, the wind-powered pumping device, and the solar-powered pumping device, which is for setting up the wind and solar parameters and a time interval for switching the pumping devices.
